(19) United States
(12) Patent Application Publication
(10) Pub. No.: US 2003/0059204 A1
(43) Pub. Date: Mar. 27, 2003

(54) Video recording apparatus and video recording method

(76) Inventor: Eiki Obara, Hiki-gun (JP)

Correspondence Address: PILLSBURY WINTHROP, LLP, P.O. BOX 10500, MCLEAN, VA, 22102, US

(21) Appl. No.: 10/096,103

(22) Filed: Mar. 13, 2002

(30) Foreign Application Priority Data
Sep. 25, 2001 (JP) 2001-292003

(51) Int. Cl. H04N 5/91; H04N 7/08

(52) U.S. Cl. 386/92

(57) ABSTRACT

A first recording section for recording video data on a first recording medium removably settable in an apparatus and a second recording section for recording the video data on a second recording medium built into the apparatus and greater in capacity than the first recording medium are provided. With the video data recorded by the second recording section on the second recording medium, the video data is recorded by the first recording section on the first recording medium on the basis of predetermined input information.

### CROSS-REFERENCE TO RELATED APPLICATIONS

This application is based upon and claims the benefit of priority from the prior Japanese Patent Application No. 2001-292003, filed Sep. 25, 2001, the entire contents of which are incorporated herein by reference.

### BACKGROUND OF THE INVENTION

1. Field of the Invention

The present invention relates to an improvement in a video recording apparatus and video recording method for recording video data which is obtained, for example, from a surveillance video camera, etc., onto a recording medium.

2. Description of the Related Art

As conventionally known, for a video recording system applied to, for example, surveillance with the use of a video camera, etc., it is usually necessary to record for a long period of time. If, therefore, the video data obtained from the video camera is recorded as it is, it is necessary to use a recording medium of a large capacity.

In the video recording system adapted for surveillance usage, on the other hand, it is not necessary at all times to continuously record the video data obtained from a video camera. In this type of video recording system, therefore, the video data is recorded intermittently and, by doing so, the amount of video data recorded is reduced, thus achieving a saving in capacity of the recording medium. The technique for recording video data intermittently in this way is sometimes referred to as “time lapse recording”.

When used for surveillance, etc., a plurality of sites are often involved as surveillance sites. In this case, a plurality of video cameras are mounted at a plurality of surveillance sites and the video data obtained from the respective video cameras are sequentially selectively switched for recording. By doing so, the video data of a plurality of channels can be recorded in an intermittent way.

In this type of video recording system, a removable type of recording medium, such as DVD (Digital Versatile Disk)-RAM(Random Access Memory), or a fixed type of recording medium, such as a hard disk, built into an apparatus body is used, to enable high-speed recording/reproduction.

In this case, DVD-RAM is advantageous in that it is exchangeable when the disc is full, and has good long-term storage properties. DVD-RAM has recently attained as large a capacity as 4.7 GB (Giga Bytes). It may be said, however, that a fully-practical recording capacity has yet to be achieved, when consideration is given to a still longer recording in excess of 24 hours.

In recent times, the hard disk, even being of a 3.5 inch class, has attained as large a capacity as 40 GB, which is practically satisfactory as a recording capacity. In general, however, a hard disk has a structure not easily exchangeable and, upon full capacity being reached, must be erased so that new data may be recorded.

In the case where, therefore, a hard disk is used as the recording medium, and important video data needs to be transferred to another recording medium, such as a DVD-ROM, suitable for long-time storage, it is therefore cumbersome and inconvenient for the user to bring this about.

As is evident from the above, if use is made of, as a recording medium, a removable medium, such as DVD-ROM, in a present-day video recording system for surveillance, it is not suitable for long-time recording in view of its lower recording capacity, thus presenting a problem.

Further, in the case where use if made of, as a recording medium, an fixed medium, such as a hard disk, it is necessary that, if the video data is to be saved, it be transferred to another recording medium.

For example, Jpn. Pat. Appln. KOKAI Publication No. 9-238307, etc., discloses a known example relating to a surveillance video recording/reproducing system.

In this publication, a surveillance video is endlessly recorded in a RAM at a normal time; at a time point at which a detection signal is generated from a surveillance sensor, a recording of it into a RAM is automatically stopped; a subsequently obtained surveillance image of a constant time is recorded on a video disk for saving; and, after this, a surveillance image preceding the generation of the detection signal is transferred from the RAM to the video disk.

In the recording/reproducing apparatus for recording and reproducing the surveillance video as shown in the publication, however, at each time a detection signal is generated from the sensor, the surveillance image is transferred from the RAM to the video disk. It is, therefore, cumbersome to control the processing operation and, further, there arises an inconvenience that the surveillance image obtained from the camera during a transfer operation is not recorded on either the RAM or the video disk.

### BRIEF SUMMARY OF THE INVENTION

The present invention has been achieved with the above in view and the object of the present invention is to provide a video recording apparatus and video recording method capable of recording an image for a longer time period and, without the need to transfer data at a time of saving video data, capable of ensuring an enhanced convenience to the user.

According to one aspect of the present invention, there is provided a video recording apparatus comprising a first recording section capable of recording video information on a first recording medium removably settable in the apparatus, a second recording section capable of recording video information on a second recording medium built into the apparatus and greater in capacity than the first recording medium, and a control section allowing the video information to be recorded by the first recording section on the first recording medium, with the video information recorded by the second recording section on the second recording medium, on the basis of predetermined input information.

According to another aspect of the present invention, there is provided a video recording method comprising preparing a first recording section capable of recording video information on a first recording medium removably settable in an apparatus and a second recording section capable of recording video information on a second recording medium built into the apparatus and greater in capacity than the first recording medium, and allowing video information to be recorded by the first recording section on the first recording medium, with the video information recorded by the second recording section on the second recording medium, on the basis of predetermined input information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows one embodiment of the present invention and a schematic view for explaining a structure of a surveillance video recording/reproducing system;

FIG. 2 is a block diagram for explaining a detail of a surveillance video recording/reproducing apparatus of the embodiment above;

FIGS. 3A to 3C are a timing chart for explaining the operations of a HDD and disk drive in connection with an alarm signal in the embodiment;

FIG. 4 is a view for explaining a flow of video data between a video processing circuit and recording media in the embodiment;

FIGS. 5A to 5C are a timing chart for explaining the operations of a HDD and disk drive in connection with an alarm signal in a variant of the present embodiment; and

FIG. 6 is a view for explaining a flow of video data between a video processing circuit and recording media in a variant of the present embodiment.

### DETAILED DESCRIPTION OF THE INVENTION

One embodiment of the present invention will be described in more detail below with reference to the accompanying drawings.

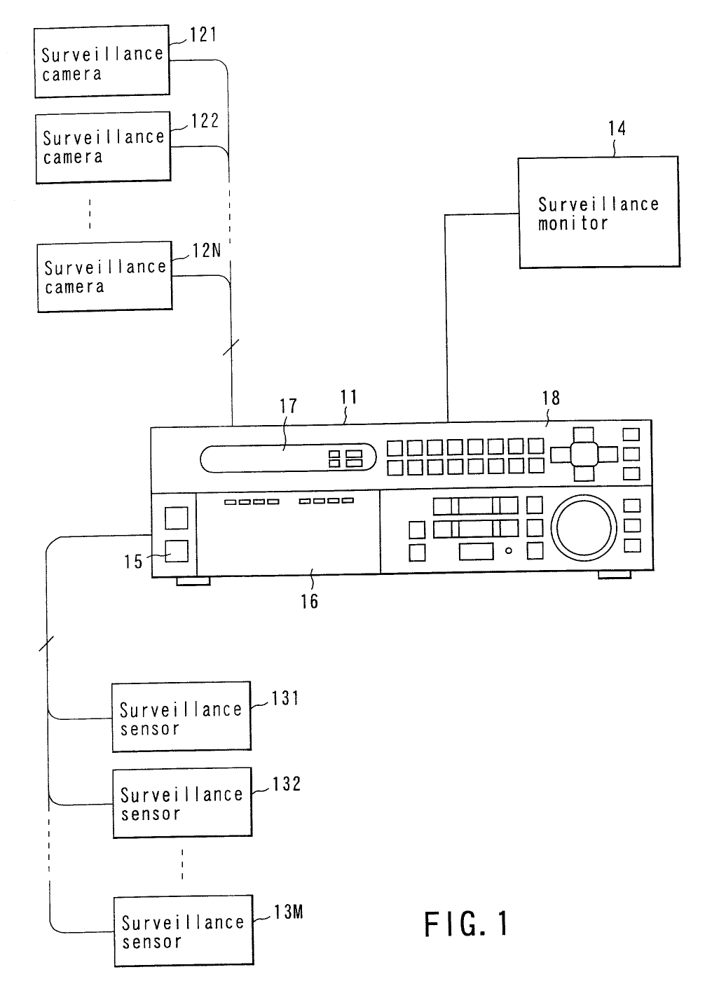

FIG. 1 is a diagrammatic view showing a surveillance video recording/reproducing system explained in connection with the embodiment. This surveillance video recording/reproducing system has a plurality of surveillance cameras 121, 122, . . . , 12N, a plurality of surveillance sensors 131, 132, . . . , 13M, and a surveillance monitor 14 which are connected to a surveillance video recording/reproducing apparatus 11.

Further, the surveillance video recording/reproducing apparatus 11 can handle, as will be detailed below, both an optical disk, such as a DVD-RAM, as a recording medium, removably settable in the surveillance video recording/reproducing apparatus 11 and a hard disk, for example, which is built into the surveillance video recording/reproducing apparatus 11 and used as a recording medium for high-speed recording/reproduction with a large capacity.

In this way, the surveillance video recording/reproducing apparatus 11 can record, in a time sharing fashion, respective video signals obtained from these surveillance cameras 121, 122, . . . , 12N onto either one or both of the optical disk and hard disk. In this case, the surveillance video recording/reproducing apparatus 11 can record the video signals in a recording mode selected by the user.

Further, the surveillance video recording/reproducing apparatus 11 controls the recording operation of a corresponding surveillance image on the basis of detection outputs obtained selectively or simultaneously from the surveillance sensors 131, 132, . . . , 13M. These sensors 131, 132, . . . , 13M are located in predetermined surveillance places and detect, for example, a moving object at an entrance and exit, the opening and closing of a door, etc., and use is made of, for example, infrared sensors.

Further, the surveillance video recording/reproducing apparatus 11 can display surveillance video information which is recorded on either one of the optical disk and hard disk on the surveillance monitor 14 as an image. In this case, the surveillance video recording/reproducing apparatus 11 can display images of the plurality of surveillance places one by one in a switching fashion or as a multi-image format simultaneously.

It is to be noted that the surveillance video recording/reproducing apparatus 11 includes a power supply switch 15, a mounting section 16 for allowing the optical disk to be removably set therein, a display section 17 for displaying an operation state, a setting state, etc., and an operation section 18 for allowing the user to set various kinds of operations, states, modes, etc., and so on.

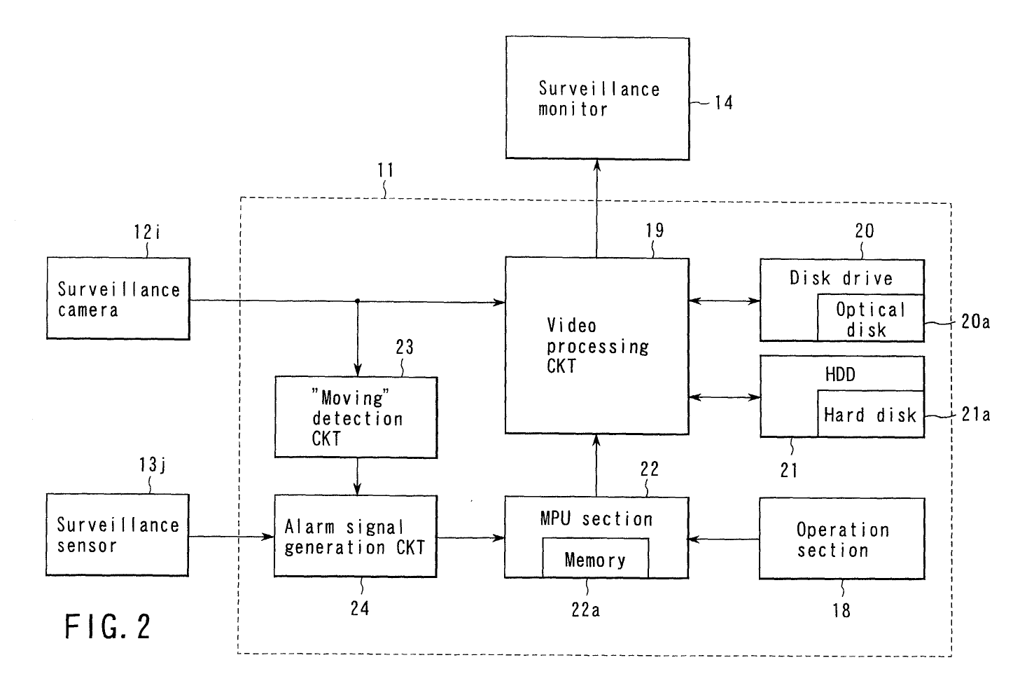

Here, FIG. 2 shows a detail of the surveillance video recording/reproducing apparatus 11. That is, video signals which are outputted from the surveillance cameras (i=an integer of 1 to N) are supplied to an image processing circuit 19. The video processing circuit 19 converts the inputted video signal to a digital one and, after performing predetermined data compression processing corresponding to a recording mode set by the user, converts the resultant data to a format suitable for recording and outputs it.

The video data outputted from the video processing circuit 19 can be supplied to a disk drive 20 and recorded on an optical disk 20a. Further, the video data outputted from the video processing circuit 19 can be supplied to a HDD (Hard Disk Drive) 21 and recorded on a hard disk 21a. In this case, the video data can be recorded on either one or both of the optical disk 20a and the hard disk 21a.

The video data recorded on the optical disk 20a is read out by the disk drive 20 and sent to the video processing circuit 19. In this case, the video processing circuit 19 performs data expansion processing on the inputted video data and, after it has been converted to a format suitable for displaying, outputs it to the surveillance monitor 14 where a corresponding image can be displayed on the surveillance monitor 14.

The video data recorded on the hard disk 21a is read out by the HDD21 and sent to an image processing circuit 19. Even in this case, the video processing circuit 19 performs data expansion processing on the inputted video data and, after it has been converted to a format suitable for displaying, outputs it to the surveillance monitor 14 where a corresponding image can be displayed.

It is to be noted that, from the video data read out from the optical disk 20a and video data read out from the hard disk 21a, either one is selected by the user and the corresponding data from the video processing circuit 19 is displayed on the surveillance monitor 14.

The above-mentioned sequence of the recording/reproducing operation is coordinately controlled by an MPU (Micro Processing Unit) section 22. The MPU section 22 receives operation information from the above-mentioned operation section 18 and controls the video processing circuit 19 on the basis of a processing program stored in its own built-in memory 22a. The MPU section 22 allows the use of its own memory 22a as a work memory or for the saving of various kinds of setting values.

Here, the video signal outputted from the surveillance camera 12i is supplied to a “moving” detection circuit 23 where the extent of a variation of an image is detected. A detection output of the “moving” detection circuit 23 is supplied to an alarm signal generation circuit 24. A detection output of the surveillance sensor 13j (j=an integer of 1 to M) is supplied to the alarm signal generation circuit 24.

The alarm signal generation circuit 24 generates an ON (abnormal time) state or an OFF (normal time) state alarm signal on the basis of the detection outputs of the “moving” detection circuit 23 and surveillance sensor 13j and delivers it as an output to the MPU section 22. In accordance with the ON or the OFF state of the alarm signal, the MPU section 22 effects control to change a recording operation of the video data to the optical disk 20a and hard disk 21a.

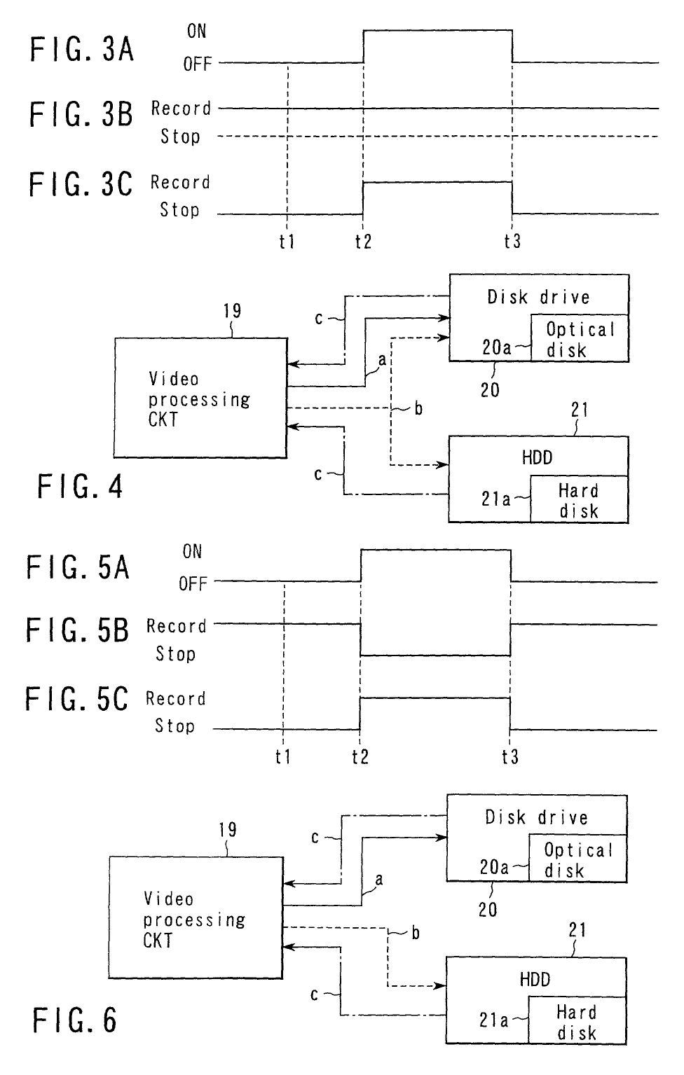

In connection with the above-mentioned surveillance video recording/reproducing apparatus 11, an explanation will be made below about its characteristic operation. FIG. 3A shows the ON and OFF times of an alarm signal, FIG. 3B shows a record operation time and record stop time of the HDD21, and FIG. 3C shows a record operation time and record stopping time of the disk drive 20. Further, FIG. 4 shows a flow of the video data between the video processing circuit 19 and the optical disk 20a and hard disk 21a.

First, as shown at a time t1 in FIG. 3A, at an OFF time of an alarm signal, that is, at a normal time, the MPU section 22 controls the HDD21 to a recording operation state, as shown in FIG. 3B. For this reason, as indicated by an arrow a on a solid line in FIG. 4, video data outputted from the video processing circuit 19 is stored in the hard disk 21a of the HDD21.

At this time, as shown in FIG. 3C, the MPU section 22 controls the disk drive 20 to a recording stopping state so that the video data outputted from the video processing circuit 19 is not recorded in the optical disk 20a.

Let it be assumed that, in such a state, as shown at a time t2 in FIG. 3A, the alarm signal is set in an ON state. At this time, the MPU section 22, while maintaining the HDD21 to a recording operation state as shown in FIG. 3B, controls the disk drive 20 to a recording operation state as shown in FIG. 3C.

By doing so, as indicated by arrows b on a dotted line in FIG. 4, the video data outputted from the video processing circuit 19 is recorded on the hard disk 21a and optical disk 20a of the HDD21 and disk drive 20, respectively. In this case, a recording mode upon the recording of the video data on the hard disk 21a and a recording mode upon the recording of the video data on the optical disk 20a can be made different from each other.

This can be realized by an initial input setting by the user at the operation section 18. Generally speaking, a higher image quality recording mode is selected when recording is made at the ON time of the alarm signal than when recording is made at the OFF time of the alarm signal.

Therefore, an image quality mode can be selected to be higher in a recording mode upon the recording of the video data on the optical disk 20a and hard disk 21a at a time following a time t2 than in a recording mode upon the recording of the video data on the hard disk 21a at a time preceding the time t2.

Further, the recording mode upon the recording of the video data on the hard disk 21a may be made the same before and after the time t2 and the recording mode upon the recording of the video data on the optical disk 20a at a time following the time t2 may be selected as being higher in image quality than the recording mode on the hard disk 21a.

As the inputting means of selecting such a recording mode, for example, the following means may be used. When, for example, the user performs an operation calling for the setting of the recording mode on the operation section 18, a plurality of kinds of recording modes are displayed as a list on a recording mode setting screen of the surveillance monitor 14 and the operator can select any desired recording mode on the mode setting screen by operating a cursor move key, a decision key, etc., at the operation section 18.

After this, as shown at a time t3 in FIG. 3A, when the alarm signal is returned back to an OFF state, the MPU section 22, controlling the HDD21 to be in a continued recording operation state as shown in FIG. 3B, controls the disk drive 20 to a recording stopping state as shown in FIG. 3C.

As indicated by the arrow a on the solid line in FIG. 4, therefore, the video data outputted from the video processing circuit 19 is again recorded only on the hard disk 21a of the HDD21.

Incidentally, the video data recorded on the optical disk 20a and video data recorded on the hard disk 21a are selectively read out from the disk drive 20 and HDD21 on the basis of a user operation. The selected data is supplied to the video processing circuit 19 as indicated by an arrow c on a dot-dash line in FIG. 4 and, by doing so, a corresponding image is displayed on the surveillance monitor 14.

According to the above-mentioned embodiment, first, the video data is recorded on the hard disk 21a at the normal time and it is, therefore, possible to record the image for a longer period of time. When the alarm signal is turned ON, the video data, being continuously recorded on the hard disk 21a, is recorded on the optical disk 20a also. It is, therefore, possible to save the video data without transferring it from the hard disk 21a to the optical disk 20a and thus to ensure an enhanced convenience to the user.

FIGS. 5A to 5C and 6 show a variant of the above-mentioned embodiment. FIG. 5A shows an alarm signal at an ON and an OFF time, FIG. 5B shows an HDD21 at a recording operation time and at a recording stopping time and FIG. 5C shows a disk drive 20 at a recording operation time and at a recording stopping time. FIG. 6 shows a flow of video data between a video processing circuit 19 and the optical disk 20a and hard disk 21a.

First, as shown at a time t1 in FIG. 5A, at an OFF time of the alarm signal, that is, at a normal time, the MPU section 22 controls HDD21 to a recording operation state as shown in FIG. 5B. As indicated by an arrow a on a solid line in FIG. 6, the video data outputted from the video processing circuit 19 is supplied to the HDD21 where it is recorded in the hard disk 21a.

At this time, as shown in FIG. 5C, the MPU section 22 controls the disk drive 20 to a recording stopping state and the video data outputted from the video processing circuit 19 is not recorded on the optical disk 20a.

Let it be assumed that, in such a time, the alarm signal is turned ON as shown in a time t2 in FIG. 5A. At this time, the MPU section 22 controls the HDD21 to a recording stopping state as shown in FIG. 5B and the disk drive 20 to a recording operation state as shown in FIG. 5C.

By doing so, as indicated by an arrow b on a dotted line in FIG. 6, the video data outputted from the video processing circuit 19 is recorded only on the optical disk 20a of the disk drive 20.

After this, when the alarm signal is returned back to an OFF state as shown at a time t3 in FIG. 5A, the MPU section 22 controls the HDD21 to a recording operation state as shown in FIG. 5B and the disk drive 20 to a recording stopping state as shown in FIG. 5C.

For this reason, the video data outputted from the video processing circuit 19 is again recorded only on the hard disk 21a of the HDD21 as indicated by the arrow a on the solid line in FIG. 6.

Incidentally, the video data recorded on the optical disk 20a and video data recorded on the hard disk 21a are selectively read out from the disk drive 20 and HDD21 on the basis of a user operation. The read-out data is supplied to the video processing circuit 19 as indicated by an arrow c on a dot-dash line in FIG. 6 and is used to display a corresponding image on the surveillance monitor 14.

According to the above-mentioned variant, even here the video data is recorded on the hard disk 21a at a normal time and it is possible to record the video data for a longer period of time. When the alarm signal is turned ON, the video data is recorded on the optical disk 20a. Therefore, without transferring the video data from the hard disk 21a to the optical disk 20a, it is possible to save the video data and thus to ensure an enhanced convenience to the user. Further, with the alarm signal at an ON state, the video data is not recorded on the hard disk 21a. It is, therefore, possible to effectively utilize the recording capacity of the hard disk 21a.

The present invention is not restricted to the above-mentioned embodiment and various changes or modifications of the present invention can be made without departing from the spirit and scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video recording apparatus comprising:
a first recording section capable of recording video information on a first recording medium removably settable in the apparatus;
a second recording section capable of recording the video information on a second recording medium built into the apparatus and larger in capacity than the first recording medium; and,
a control section allowing the video information to be recorded by the first recording section on the first recording medium, with the video information recorded by the second recording section on the second recording medium, on the basis of predetermined input information.

2. A video recording apparatus according to claim 1, wherein, with the recording of the video information by the second recording section on the second recording medium continued, the control section allows the video information to be recorded by the first recording section on the first recording medium on the basis of the predetermined input information.

3. A video recording apparatus according to claim 2, further comprising setting means for setting an image quality to be higher in a recording mode for recording the video information by the second recording section on the second recording medium after the predetermined input information has been supplied than in a recording mode for recording the video information by the second recording section on the second recording medium before the predetermined input information is supplied.

4. A video recording apparatus according to claim 1, wherein, with the recording of the video information by the second recording section on the second recording medium stopped, the control section allows the video information to be recorded by the first recording section on the first recording medium on the basis of the predetermined input information.

5. A video recording apparatus according to claim 1, wherein the predetermined input information is alarm information generated on the basis of a detection output of a sensor located in a predetermined surveillance site.

6. A video recording apparatus according to claim 1, wherein the predetermined input information is alarm information generated on the basis of a detection output of a sensor located in a predetermined surveillance site and a “moving” detection output of the video information.

7. A video recording apparatus according to claim 1, further comprising an operation section input-setting a recording mode for recording the video information by the first recording section on the first recording section and a recording mode for recording the video information by the second recording section on the second recording medium.

8. A video recording apparatus according to claim 1, further comprising setting means for setting an image quality to be higher in a recording mode for recording the video information by the first recording section on the first recording medium than a recording mode for recording the video information by the second recording section on the second recording medium.

9. A video recording apparatus according to claim 1, wherein the first recording medium is comprised of a rewritable optical disk and the second recording medium is comprised of a hard disk.

10. A video recording apparatus comprising:
first recording means capable of recording video information on a first recording medium removably settable in the apparatus;
second recording means capable of recording the video information on a second medium built in the apparatus and larger in capacity than the first recording medium; and
control means for allowing the video information to be recorded by the first recording means on the first recording medium, with the video information recorded by the second recording means on the second recording medium, on the basis of predetermined input information.

11. A video recording method comprising:
preparing a first recording section capable of recording video information on a first recording medium removably settable in the apparatus and a second recording section for recording the video information on a second recording medium built in the apparatus and larger than the first recording medium; and
allowing the video information to be recorded by the first recording section on the first recording medium, with the recording information recorded by the second recording section on the second recording medium, on the basis of predetermined input information.

12. A video recording method according to claim 11, wherein the recording of the video information by the first recording section on the first recording medium on the basis of the predetermined input information is effected with the recording of the video information by the second recording section on the second recording medium continued.

13. A video recording method according to claim 12, further comprising a setting an image quality to be higher in a recording mode for recording the video information by the second recording section on the second recording medium after the predetermined input information has been supplied than in a recording mode for recording the video information by the second recording section on the second recording medium before the predetermined input information is supplied.

14. A video recording method according to claim 11, wherein the recording of the video information by the first recording section on the first recording medium on the basis of the predetermined input information is effected with the recording of the video information by the second recording section on the second recording medium stopped.

15. A video recording method according to claim 11, further comprising an input-setting a recording mode for recording the video information by the first recording section on the first recording medium and a recording mode for recording the video information by the second recording section on the second recording medium.

16. A video recording method according to claim 11, further comprising a setting an image quality to be higher in a recording mode for recording the video information by the first recording section on the first recording medium than in a recording mode for recording the video information by the second recording section on the second recording medium.

17. A video recording/reproducing method comprising:
preparing a first recording section capable of recording video information on a first recording medium removably settable in the apparatus and a second recording section capable of recording the video information on a second recording medium built in the apparatus and larger in capacity than the first recording medium;
allowing the video information to be recorded by the first recording section on the first recording medium, with the video information recorded by the second recording section on the second recording medium, on the basis of predetermined input information; and
selectively reproducing the video information recorded on the first and second recording medium.

18. A video recording/reproducing method according to claim 17, wherein the recording of the video information by the first recording section on the first recording medium is effected with the recording of the video information by the second recording section on the second recording medium continued.

19. A video recording/reproducing method according to claim 17, wherein the recording of the video information by the first recording section on the first recording medium is effected with the recording of the image information by the second recording section on the second recording medium stepped.
